(19) United States
(12) Patent Application Publication
(10) Pub. No.: US 2004/0052023 A1
(43) Pub. Date: Mar. 18, 2004

(54) Vsc-converter

(76) Inventor: Gunnar Asplund, Ludvika (SE)

Correspondence Address: SWIDLER BERLIN SHEREFF FRIEDMAN, LLP, 3000 K STREET, NW, BOX IP, WASHINGTON, DC, 20007, US

(21) Appl. No.: 10/451,256

(22) PCT Filed: Dec. 14, 2001
(86) PCT No.: PCT/SE01/02775

(30) Foreign Application Priority Data
Dec. 20, 2000 (SE) 0004711-8

(51) Int. Cl. H02H 3/20

(52) U.S. Cl. 361/91.1

(57) ABSTRACT

A VSC-converter for converting direct voltage into alternating voltage and vice versa, comprising several current valves (1; 10-13), each current valve comprising a semiconductor element (2) of turn-off type and a first rectifying member (3) connected in anti-parallel therewith. At least one of the current valves is provided with a circuit for over voltage protecting connected in parallel with the current valve, which circuit comprises a series connection of a surge arrester (5) and a second rectifying member (6), the second rectifying member (6) being connected in anti parallel with the first rectifying member (6) being connected in anti parallel with the first rectifying member (3) included in said at least one current valve. The invention also relates to a VSC-converter where each of the series connected circuits (30) that build up the current valves of the converter comprises, in at least one of the current valves, a surge arrester (5) connected in parallel with a capacitor (33) included in the circuit (30) and in series with a rectifying component (34) included in the circuit (30).

### FIELD OF THE INVENTION AND PRIOR ART

The present invention relates to a VSC-converter according to the preamble of the subsequent claims 1, 2 and 6, respectively.

A VSC-converter for connection between a direct voltage network and an alternating voltage network is previously known e.g. from the thesis “PWM and control of two and three level High Power Voltage Source Converters” by Anders Lindberg, Royal Institute of Technology, Stockholm, 1995, in which publication a plant for transmitting electric power through a direct voltage network for high voltage direct current (HVDC) while utilizing such a converter is described. Before the creation of this thesis, plants for transmitting electric power between a direct voltage network and an alternating voltage network have been based upon the use of network commutated CSC(Current Source Converter)-converters in stations for power transmission. However, in this thesis a totally new concept is described, which is based on instead using VSC(Voltage Source Converter)-converters for forced commutation for transmitting electric power between a direct voltage network being voltage stiff therethrough, in the case in question for high voltage direct current, and alternating voltage networks connected thereto, which offers several considerable advantages as compared to the use of network commutated CSC-converters in HVDC, among which it may be mentioned that the consumption of active and reactive pow r may be controlled independently of each other and that there is no risk of commutation faults in the converters and thereby no risk of commutation faults being transmitted between different HVDC-links, as may occur with network commutated CSC-s. Furthermore, it is possible to feed a weak alternating voltage network or a network without any generation of its own (a dead alternating voltage network). There are also further advantages.

The invention is not limited to this application, on the contrary the converter can as well be used for conversion in a SVC (Static Var Compensator), in which case the direct voltage network is replaced by a DC-link. “Network” is also to be given a very broad meaning, and it does not have to be any network in the proper sense of this word. The voltages on the direct voltage side of the converter are with advantage high, 10-400 kV, preferably 50-400 kV.

When transmitting direct voltage on a direct voltage network connected to a VSC-converter it is desirable to have a voltage as high as possible, since the transmission losses are reduced with increasing voltage. However, an increase of this voltage implies increased risks that the series connected semiconductor elements of turn-off type in the current valves of the converter are subjected to overvoltages which may have a destroying effect on said semiconductor elements. The risk of overvoltages is particularly high in the two current valves, here denominated the outer current valves, arranged most closely to the respective pole of the direct voltage side of a VSC-converter of the type with a so called flying capacitor. Therefore, there is a great need of protecting in particular these outer current valves against overvoltages. The conventional method for protection of a component against overvoltage is to connect a surge arrester in parallel with the component. A surge arrester does not conduct any electric current when the voltage across the surge arrester is lower than a certain limit value, which limit value is determined by the design of the surge arrester. When the voltage across the surge arrester exceeds this limit value, the surge arrester will however be fully conducting, which results in that essentially all current will by-pass said component via the surge arrester. This drastically reduces the voltage across said component to a level which is not harmful to the component.

However, a VSC-converter is normally operated at high switching frequency, in the order of 1-2 kHz, wherefore it is very difficult to protect the current valves of a VSC-converter against overvoltages by means of a surge arrester in the above indicated way. The high switching frequency implies that a surge arrester, which is connected over the current valve, is subjected to very rapid voltage jumps, which in its turn results in a heating of the surge arrester and in high power losses in the surge arrester. The heating implies that the surge arrester runs the risk of being rapidly destroyed and “getting used up”. For the surge arrester to be able to manage the high switching frequencies here in question it must be given such a powerful dimensioning that the protection level, i.e. the voltage value at which the surge arrester becomes current conducting, will lie on such a high level that the surge arrester in practice will not be able to make any use for the protection of the semiconductor elements of the current valves.

### OBJECT OF THE INVENTION

An object of the present invention is to achieve a VSC-converter in which the semiconductor elements of one or several of the current valves of the VSC-converter are protected against overvoltages in a simple and efficient manner.

### SUMMARY OF THE INVENTION

According to the invention, said object is achieved by means of a VSC-convert r according to the preamble of claim 1 and claim 2, respectively, having the features indicated in the characterizing part of claim 1 and claim 2, respectively.

The solution according to the invention implies that a protected current valve is protected against overvoltages by means of the surge arrester included in the circuit for overvoltage protection, the surge arrester in its turn being protected against the high frequency voltage changes by means of the rectifying member included in said circuit in co-operation with the capacitor function included in the surge arrester. The surge arrester always has a certain capacitance and resistance and can somewhat simplified be considered as a capacitor connected in parallel with a resistor. According to the invention, the inherent capacitance of the surge arrester is used to secure, in co-operation with the rectifying member, that the surge arrester will not be subjected to high frequency voltage changes. The inherent capacitance of the surge arrester, which can be considered as an internal capacitor of the surge arrester, will together with the rectifying member achieve a so called peak rectification, the “internal capacitor” of the surge arrester maintaining the voltage across the surge arrester so that the surge arrester only is subjected to direct voltage. In this way, the surge arrester is subjected to less “wear” and can consequently be given a considerably smaller dimensioning as compared to the case when the surge arrester is subjected to the high frequency voltage changes.

According to a preferred embodiment of the invention, a capacitor is connected in parallel with the surge arrester and in series with the rectifying member included in the circuit for overvoltage protection. The capacitor constitutes a complement to the “internal capacitor” of the surge arrester in said circuit and results in a reinforced protection of the surge arrester against high frequency voltage changes.

According to the invention, the above mentioned object is also achieved by m ans of a VSC-converter according to the preamble of claim 6 having the features indicated in the characterizing part of claim 6.

The current valves of a VSC-converter conventionally comprise several series connected circuits, each of which circuits comprises inter alia a semiconductor component of turn-off type and a first rectifying component connected in anti-parallel therewith. Each such series connected circuit already comprises a capacitor connected in parallel with the semiconductor component and a second rectifying component connected in series with the capacitor, in parallel with the semiconductor component and in anti-parallel with the first rectifying component. In order to achieve a circuit which in the above described way protects a current valve against overvoltages by means of a surge arrester and simultaneously protects the surge arrester from high frequency voltage changes, each of the series connected circuits included in said current valve only has to be supplemented with a surge arrester connected in parallel over the capacitor included in the respective series connected circuit. One of the advantages achieved by arranging the overvoltage protection at each separate semiconductor component of turn-off type in the current valve in this manner, instead of arranging a common overvoltage protection for all the series connected semiconductor components of turn-off type included in the current valve, is of course that no supplementary rectifying member, and where appropriate no supplementary capacitor, has to be provided. The saving of this rectifying member, and where appropriated the capacitor, normally outbalances the cost for the increased number of surge arresters required. It is also worth noticing that smaller and cheaper surge arresters can be used in this latter case as compared with the case where all semiconductor components of turn-off type included in the current valve are protected by a common overvoltage protection. Furthermore, the current valve and its overcurrent protection will b less bulky in the latter case. Furthermore, the arrangement of a separate overvoltage protection at each separate semiconductor component of turn-off type implies that separate components in the current valve can be protected in case of occasional unbalances of the voltage inside the current valve.

Further preferred embodiments of the converters according to the invention will appear from the dependent claims and the subsequent description.

### BRIEF DESCRIPTION OF THE DRAWINGS

With reference to the appended drawings, the invention will in the following be more closely described by means of embodiment examples. It is shown in:

FIG. 1 a simplified circuit diagram illustrating a current valve included in a VSC-converter according to the invention provided with a circuit for overvoltage protection according to a first variant,

FIG. 2 a simplified circuit diagram illustrating a current valve included in a VSC-converter according to the invention provided with a circuit for overvoltage protection according to a second variant,

FIG. 3 a simplified circuit diagram illustrating a VSC-converter according to a variant of the invention, and

FIG. 4 a simplified circuit diagram illustrating a so-called transistor position in a current valve included in a VSC-converter according to a further variant of the invention.

### DETAILED DESCRIPTION OF PREFERRED EMBODIMENTS

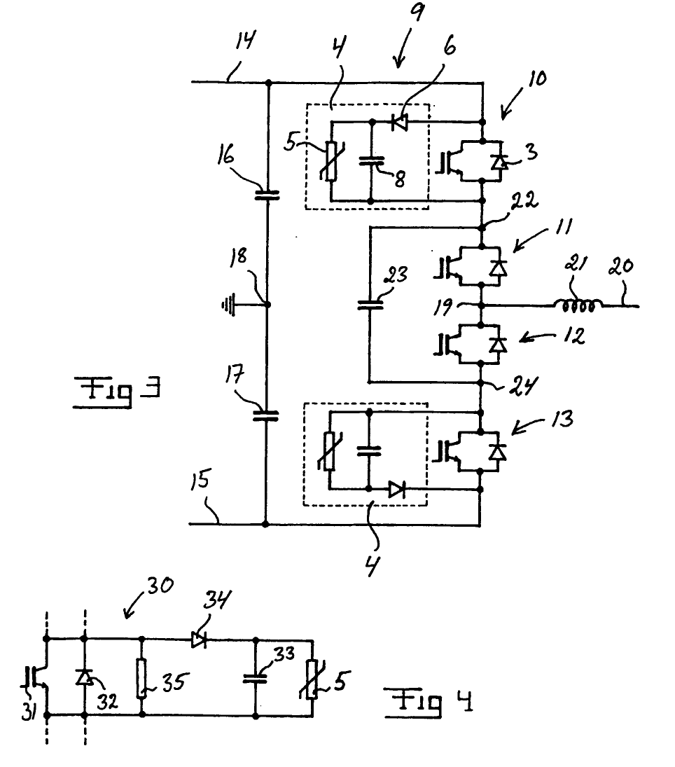

VSC-converters of several different types are known. In all types, a VSC-converter comprises a number of so called current valves, each of which comprises a semiconductor element of turn-off type, such as an IGBT (Insulated Gate Bipolar Transistor) or a GTO (Gate Turn-Off Thyristor), and a rectifying member in the form of a diode, normally a so called free wheeling diode, connected in anti-parallel therewith. Each semiconductor element of turn-off type is normally built up of several, series connected, simultaneously controlled semiconductor elements of turn-off type, such as several separate IGBT-s or GTO-s. In high voltage applications it is required a comparatively high number of such semiconductor components for holding the voltage to be held by each current valve in the blocking state. In the corresponding manner, each rectifying member is built up of several series connected rectifying components. The semiconductor components of turn-off type and the rectifying components are in the current valve arranged in several series connected circuits, each circuit comprising inter alia a semiconductor component of turn-off type and a rectifying component connected in anti-parallel therewith. The more detailed construction of such a circuit will be described later with reference to FIG. 4.

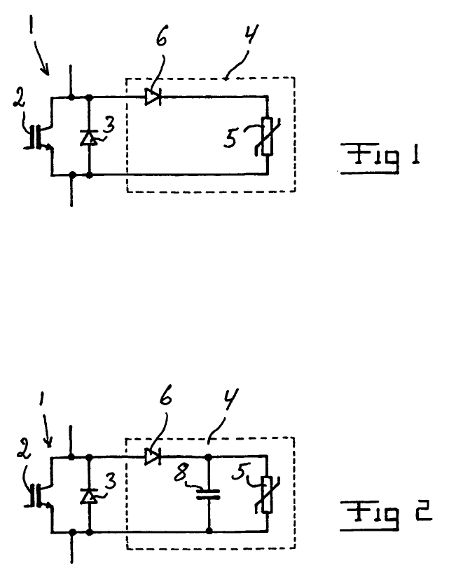

A current valve 1 included in a VSC-converter according to the invention is illustrated in FIG. 1. This current valve 1 comprises, in accordance with the above indicated, a semiconductor element 2 of turn-off type, such as an IGBT or a GTO, and a rectifying member 3 in the form of a diode, such as a free wheeling diode, connected in anti-parallel therewith. Although only the symbols for one semiconductor element 2 of turn-off type and one rectifying member 3 are shown, these symbols can in accordance with the above indicated represent several semiconductor components of turn-off type and rectifying components, respectively. This also applies to the corresponding symbols in FIGS. 2 and 3.

According to the invention, the current valve 1 illustrated in FIG. 1 is provided with an overvoltage protection 4 for protection of the semiconductor element 2 of turn-off type included in the current valve against overvoltages. In the embodiment illustrated in FIG. 1, this overvoltage protection 4 consists of a circuit connected in parallel with the current valve 1, which circuit comprises a series connection of a surge arrester 5 and a rectifying member 6, this rectifying member 6 being connected in anti-parallel with the rectifying member 3 of the current valve. The rectifying member 6 included in the overvoltage protection 4 may, like the rectifying member 3 of the current valve, consist of several series connected rectifying components in the form of diodes, such as free wheeling diodes.

The inherent capacitance of the surge arrester will, as previously mentioned, together with the rectifying member 6 achieve a so called peak rectification, the “internal capacitor” of the surge arrester maintaining the voltage across the surge arrester 5 so that this only is subjected to direct voltage and thereby is protected against high frequency voltage changes.

The surge arrester 5 is of a conventional type, such as a zinc oxide surge arrester, which is also denominated MOV (Metal Oxide Varistor), and normally conducts a very low current, but when the voltage across the surge arrester exceeds a certain level it will conduct a substantially increased current.

A current valve included in a VSC-converter according to the invention and provided with an overvoltage protection according to a second variant is illustrated in FIG. 2. The current valve 1 has the same construction as the current valve described with reference to FIG. 1. Also here, the overvoltage protection 4 consists of a circuit connected in parallel with the current valve 1, which circuit comprises a surge arrester 5 and a rectifying member 6, connected in series therewith, the rectifying member 6 being connected in anti-parallel with the rectifying member 3 of the current valve. However, in the variant shown in FIG. 2 the circuit for overvoltage protection is supplemented with a capacitor 8, which is connected in parallel with the surge arrester 5 and in series with the rectifying member 6 included in this circuit. Said capacitor 8 will as previously mentioned supplement the “internal capacitor” of the surge arrester and results in a reinforced protection of the surge arrester 5 against high frequency voltage changes.

A VSC-converter 9 according to a preferred variant of the Invention is illustrated in FIG. 3. The shown converter is of a type having a so-called “flying capacitor”. In FIG. 3, only that part of the converter that is connected to one phase of an alternating voltage phase line is shown, the number of phases normally being three, but it is also possible that this constitutes the entire converter when this is connected to a one phase alternating voltage network. The shown part of the converter constitutes a so-called phase leg and a VSC-converter adapted to a three phase alternating voltage network comprises three phase legs of the type shown. The phase leg of the VSC-converter in question comprises four current valves 10-13 connected in series between the two poles 14, 15 of a direct voltage side of the converter. The current valves 10-13 have the same construction as the current valve described with reference to FIG. 1. Two series connected capacitors 16, 17 are arranged between the two poles 14, 15, and a point 18 between these capacitors is normally connected to ground so as to provide the potentials +U/2 and −U/2, respectively, at the respective pole, U being the voltage between the two poles 14, 15.

A first midpoint 19 of the series connection between the two current valves 11 and 12, which constitutes the phase output of the converter, is connected to an alternating voltage phase line 20 via an inductor 21. In this way, said series connection is divided into two equal parts with two current valves 10, 11 and 12, 13, respectively, in each such part.

A second midpoint 22 between two of said current valves 10, 11 of one of the parts of the series connection is via a flying capacitor 23 connected to a, with respect to the phase output, corresponding second midpoint 24 of the other part of the series connection.

The function of a VSC-converter of the type illustrated in FIG. 3 is well known to the person skilled in the art and will therefore not be more closely described here.

Each of the current valves 10, 13 arranged most closely to the respective pole 14, 15 is according to the invention provided with an overvoltage protection 4 of the kind described with reference to FIG. 1 or FIG. 2, which consequently consists of a circuit connected in parallel with the respective current valve 10, 13, said circuit comprising a surge arrester 5 and a rectifying member 6 connected in series therewith, the rectifying member 6 being connected in anti-parallel with the rectifying member 3 of the respective current valve. FIG. 3 shows the variant where the circuit for overvoltage protection has a supplementary capacitor 8 connected in parallel with the surge arrester 5 and in series with the rectifying member 6 included in the circuit. However, the overvoltage protections could here, like the overvoltage protection illustrated in FIG. 1, be designed without said capacitor 8.

One of the above mentioned series connected circuits of a current valve included in a VSC-converter according to a further variant of the invention is illustrated in FIG. 4. As mentioned above, a VSC-converter conventionally comprises several such series connected circuits, each of which circuits comprising inter alia a semiconductor component 31 of turn-off type and a first rectifying component 32 connected in anti-parallel therewith. Such a circuit is often denominated transistor position. The circuit 30 further comprises a capacitor 33 connected in parallel with the s miconductor component 31 of turn-off type, and a second rectifying component 34 connected in series with the capacitor 33, in parallel with the semiconductor component 31 of turn-off type and in anti-parallel with the first rectifying component 32. The circuit 30 further comprises a resistor 35 connected in parallel with said components 30-34. According to the present variant of the invention, each of the series connected circuits 30 in at least one of the current valves of the VSC-converter is provided with a surge arrester 50 connected in parallel with said capacitor 33 and in series with said second rectifying component 34. The rectifying components 32, 34 both consist of diodes, such as free wheeling diodes, and the surge arrester 5 is of the type previously mentioned.

The surge arrester 5 of the respective circuit 30 will function as an overvoltage protection for the semiconductor component 31 of turn-off type at the same time as the capacitor 33 and the second rectifying component 34 protect the surge arrester 5 against high frequency voltage changes.

The invention is of course not in any way restricted to the preferred embodiments described above, on the contrary many possibilities to modifications thereof should be apparent to a person skilled in the art without departing from the basic idea of the invention such as defined in the appended claims.

1. A VSC-converter for converting direct voltage into alternating voltage and vice versa, comprising several current valves (1), each current valve comprising a semiconductor element (2) of turn-off type and a first rectifying member (3) connected in anti-parallel therewith, characterized in that at least one of the current valves is provided with a circuit for over voltage protection connected in parallel with the current valve (1), which circuit comprises a series connection of a surge arrester (5) and a second rectifying member (6), the second rectifying member (6) being connected in anti-parallel with the first rectifying member (3) included in said at least one current valve.

2. A VSC-converter for converting direct voltage into alternating voltage and vice versa, which comprises a series connection of at least four current valves (10-14) arranged between two poles (14, 15), a positive and a negative, of a direct voltage side of the converter, each current valve comprising a semiconductor element (2) of turn-off type and a first rectifying member (3) connected in anti-parallel therewith, and an alternating voltage phase line (20) connected to a first midpoint (19), denominated phase output, of the series connection between two current valves while dividing the series connection into two equal parts, the series connection having a second midpoint (22) between two of said current valves of one of the parts of the series connection, said second midpoint (22) being connected via a flying capacitor (23) to a, with respect to the phase output, corresponding second midpoint (24) of the other part of the series connection, characterized in that the current valves (10, 13) connected between one (14) of the poles and said second midpoint (22) of one of the parts of the series connection and between the other pole (15) and said second midpoint (24) of the other part of the series connection each comprises a circuit for over voltage protection connected in parallel with the current valve (10, 13), which circuit comprises a series connection of a surge arrester (5) and a second rectifying member (6), the second rectifying member (6) of the respective circuit being connected in anti-parallel with the first rectifying member (3) included in the current valve over which the circuit is connected.

3. A VSC-converter according to any of the preceding claims, characterized in that a capacitor (8) is connected in parallel with the surge arrester (5) and in series with the second rectifying member (6) in the respective circuit.

4. A VSC-converter according to any of the preceding claims, characterized in that the surge arrester (5) is a zinc oxide surge arrester.

5. A VSC-converter according to any of the preceding claims, characterized in that said second rectifying member (6) is a diode, preferably a free wheeling diode.

6. VSC-converter for converting direct voltage into alternating voltage and vice versa, comprising several current valves, each current valve consisting of several series connected circuits (30), said circuits each comprising a semiconductor component (31) of turn-off type, a first rectifying component (32) connected in anti-parallel therewith, a capacitor (33) connected in parallel with the semiconductor component (31) of turn-off type, and a second rectifying component (34) connected in series with the capacitor (33), in parallel with the semiconductor component (31) of turn-off type and in anti-parallel with the first rectifying component (32), characterized in that each of the series connected circuits (30) of at least one of the current valves comprises a surge arrester (5) connected in parallel with said capacitor (33) and in series with said second rectifying component (34).

7. A VSC-converter according to claim 6, characterized in that the surge arrester (5) is a zinc oxide surge arrester.
